(19) United States
(12) Patent Application Publication
(10) Pub. No.: US 2022/0048042 A1
(43) Pub. Date: Feb. 17, 2022

(54) MATERIAL FEED PROCESS AND ASSEMBLY FOR A ROTARY MAGNETIC SEPARATOR

(71) Applicants: Michael John FLANAGAN, Northcliff (ZA); Rory Michael FLANAGAN, Florida Glen (ZA)

(72) Inventor: Michael John FLANAGAN, Northcliff (ZA)

(21) Appl. No.: 17/312,670

(22) PCT Filed: Mar. 16, 2020
(86) PCT No.: PCT/IB2020/052360

§ 371 Date: Jun. 10, 2021

(30) Foreign Application Priority Data
Mar. 19, 2019 (ZA) 2019/01683

(51) Int. Cl. B03C 1/18; B03C 1/12

(52) U.S. Cl. CPC B03C 1/18; B03C 2201/18; B03C 1/12

(57) ABSTRACT

The invention provides a material feed process for magnetically separating magnetic and non-magnetic particles from a material feed by means of a magnetic roller separator wherein the process is characterised therein that particle separation is independent of centrifugal force, and where the process can equally well be applied to both wet and dry particle separation. The process specifically provides feeding the particles at an incident zone above the horizontal axis centre line, and separating the magnetic and non-magnetic particles at opposite rotational sides of the roller.

### INTRODUCTION

The invention provides a material feed process and assembly for magnetically separating magnetic and non-magnetic particles from a material feed by means of a magnetic roller separator wherein the process is characterised therein that particle separation is independent of centrifugal force. The invention is further characterised therein that it can equally well be applied to both wet and dry particle separation.

### BACKGROUND TO THE INVENTION

Rotary magnetic separators with permanent magnets have been used for decades to separate magnetic and non-magnetic particles in a material feed. They are used specifically for concentration or purification of industrial minerals in dry and wet processes. Rotary magnetic separators can be of a drum type, in which a cylinder rotates around a static magnet array; or of a roll type, in which a rotating magnet is installed at a head roller of a belt conveyor.

Rotary magnetic separators are categorised into three categories according to the magnetic field flux density on the surface of the cylinder (drum) or the rotating magnet (roll):

(i) LIMS (Low Intensity Magnetic Separator)—i.e. a drum type dry or wet separator with ferrite magnets of 0.1 to 0.2 tesla;

(ii) MIMS (Medium Intensity Magnetic Separator)—i.e. a drum type dry or wet separator with neodymium magnets of 0.4 to 0.6 tesla; and

(iii) HIMS (High Intensity Magnetic Separator)—i.e. a roll type dry separator with neodymium magnets of 1.0 to 1.2 tesla.

Dry or wet LIMS are used for the concentration of magnetite iron ore, while wet LIMS are used for the concentration of magnetic medium, magnetite or ferrosilicon in dense media separation plants (DMS). MIMS (dry or wet) are used for the concentration of ilmenite from Heavy Mineral Concentrate (HMC). HIMS (dry) are used for the purification of mineral sands such as silica, rutile and zircon.

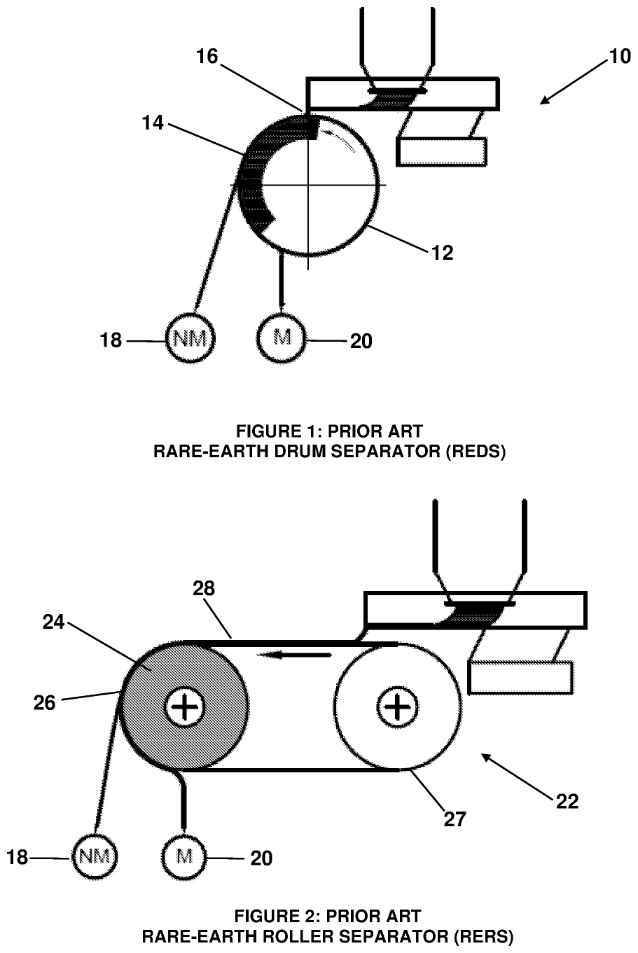

In the industrial minerals industry MIMS drums are known as Rare-Earth Drum Separators (REDS), while HIMS rollers are known as Rare-Earth Roller Separators (RERS). FIG. 1 (prior art) provides a schematic illustration of a dry feed REDS, while FIG. 2 (prior art) provides a schematic illustration of a dry feed RERS.

(iv) The FIG. 1 REDS [10] is characterised therein that a non-magnetic drum shell [12] rotates around a plurality of static magnets [14]. The magnets [14] are positioned substantially at an anti-clockwise side of the drum shell [12] relative to a vertical drum axis line. Feed material is fed onto a top surface [16] of the drum such that non-magnetic particles [18] and magnetic particles [20] are both carried to the anti-clockwise side of the drum [12] where the non-magnetic particles [18] are dispelled from the drum [12] under centrifugal force, while the magnetic particles [20] are retained by the magnetic field on the drum surface and are deflected from the drum surface only when they move outside of the magnetic field.

(v) The RERS [22] of FIG. 2 is characterised therein that a rotating magnet [24] is installed at a head roller [26] of a short belt conveyer [28]. Feed material is introduced onto the belt conveyer [28] approximate a tail roller [27] and non-magnetic particles [18] and magnetic particles [20] are both carried to an anti-clockwise side of the head roller [26] where the non-magnetic particles [18] are dispelled from the head roller [26] through centrifugal force, while the magnetic particles [20] are retained by the magnetic field of the head roller [26] until they move outside of the magnetic field.

Separation efficiency of permanent magnet roller separators requires a balance of centrifugal force versus magnetic force and is affected by design, process and feed variables. In order to achieve optimal separation performance on such magnetic separators, it is critical to control, inter alia, particle size and shape, particle density and feed depth, magnetic field strength of the roller, roller speed and feed rate.

However, both REDS and RERS are characterised by low capacity, low feed rate and the need for multi-stage processing of the non-magnetic or magnetic material in order to achieve sufficient separation. One of the most important factors in magnetic particle separation is roller speed, and hence centrifugal force. Centrifugal force and positioning of the magnetic separator have been proven to have a significantly greater influence on particle separation than material feed rate. The weaker magnetic the material to be separated is, the lower the centrifugal force should be.

The feed rate of permanent magnet roller separators is determined by linear speed of the drum or belt and the material layer height (depth) on the drum or belt, according to the following mathematical equation:

Q=V×H×3.6

Wherein Q=Capacity (in m³/h/m); V=Speed of the drum or belt (in m/sec); and H=material layer height (depth) on the drum or belt (in mm).

For a roll D m diameter, rotating at N rpm:

V=(π×D×N)/60

The angle θ that material is thrown off a pulley (CEMA 1997) is:

Cos⁻¹=V²/(r×9.81)

For a 100 mm (r 0.05 m) diameter roll, V is:

θ=30° N=124V=0.65 m/s

θ=45° N=112V=0.59 m/s

θ=60° N=95V=0.5 m/s

Using the median value ζ=45°

Q=2.124×H

A RERS magnetic roll is made up of a series of alternate neodymium magnet rings and steel discs poles (Eriez Magnetics 2016). The magnetic flux from the magnets is intensified at the poles and magnetic material is captured only at the poles. From (Gulsoy, Orhan 2004) the magnetic force is a maximum at a distance from the roll face, equal to half the pole thickness. For sands minus one millimetre, 4 mm thick magnets are sandwiched between 1 mm poles. In this configuration H is 0.5 mm.

Q=2.124×0.5=1.062

With a small amount of magnetic material in silica sand, bulk density 1.6 t/m³, the theoretical feed rate is 1.7 t/h/m.

In practice multi-stage treatment is employed, with H increased. From (Jakobs 2016) a practical feed rate for a 100 mm roll at 100 rpm, 0.52 m/s is 2 t/h/m. The maximum roll diameter used in the industry is 300 mm. V will increase with a 300 mm diameter roll, but H will remain the same as it depends only on the magnet and disc thickness, not the roll diameter. For a given particle mass, the centrifugal force is proportional to D times N squared. For a 0.3 m roll to have the same centrifugal force as a 0.1 m roll:

(D₃)×(N₃)²=(D₁)×(N₁)²

N₃=Sqr[D₁/D₃×(N₁)²]

Use 112 rpm for a 100 mm roll, N for a 300 mm roll is 64 rpm, S is 1.02 m/s.

Q=1.02×0.5×3.6=1.836

Compared with a 100 mm roll, a 1.73 increase, the square root of the diameter ratio at 1.6 t/m³ bulk density is 2.94 t/h/m. Again, in practice this would be increased with multi-stage treatment, from (Jakobs 2016) not more than 4 t/h/m for silica sand.

From the foregoing it becomes apparent that the drawbacks of both roll diameter and centrifugal force put a limit on the capacity of conventional belt fed RERS.

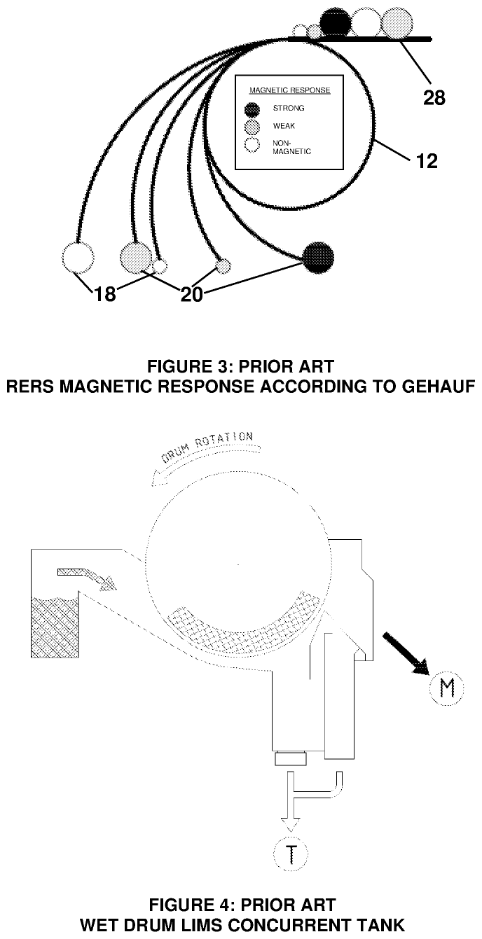

Another drawback of centrifugal force on magnetic roller separation was identified by (Gehauf 2004), who showed that large particles are thrown further than small ones. This drawback is illustrated in FIG. 3 (prior art). A large weakly magnetic particle [20] may be thrown off with small non-magnetic particles [18], thus reducing magnetic separation efficiency. An adjustable splitter plate is typically used to segregate particles. If the splitter plate is set up to capture non-magnetic particles, large weakly magnetic particles can end up with the non-magnetic particles. Conversely, if it is set up for magnetic particles, small non-magnetic particles can end up with the magnetic particles. This problem exists whether separation occurs on a REDS or the head roller of a RERS.

An answer to the particle size problem was proposed by (Ibrahim, Farahat and Boulos 2015) working on upgrading silica sands. The feed material is split into coarse and fine fractions and processed separately. This was found to improve both sand recovery and iron rejection. This is a possible solution for silica sands, which have a size range −0.6 mm +0.125 mm, but not for heavy mineral from beach sands, which are typically −0.3 mm +0.075 mm.

### WET DRUM ROTARY MAGNETIC SEPARATION

Contrary to dry drum rotary magnetic separators, which use centrifugal force in the separation process, wet drum rotary magnetic separators do not. In a wet drum magnetic separator, the drum is submerged in a bath. Feed material in a slurry is fed to the drum below a drum axis horizontal centre line and magnetic material is picked out of the slurry and attaches itself to the drum. Referring to FIGS. 4 (prior art) and 5 (prior art), two types of wet drum separators are typically encountered:

(vi) If the drum rotates in the direction of the slurry, the magnetic material is carried on the drum to a position opposite the feed point and the non-magnetic material leaves through drain holes at the bottom of the bath. This arrangement is known as concurrent type wet drum separator and is illustrated in FIG. 4 (prior art).

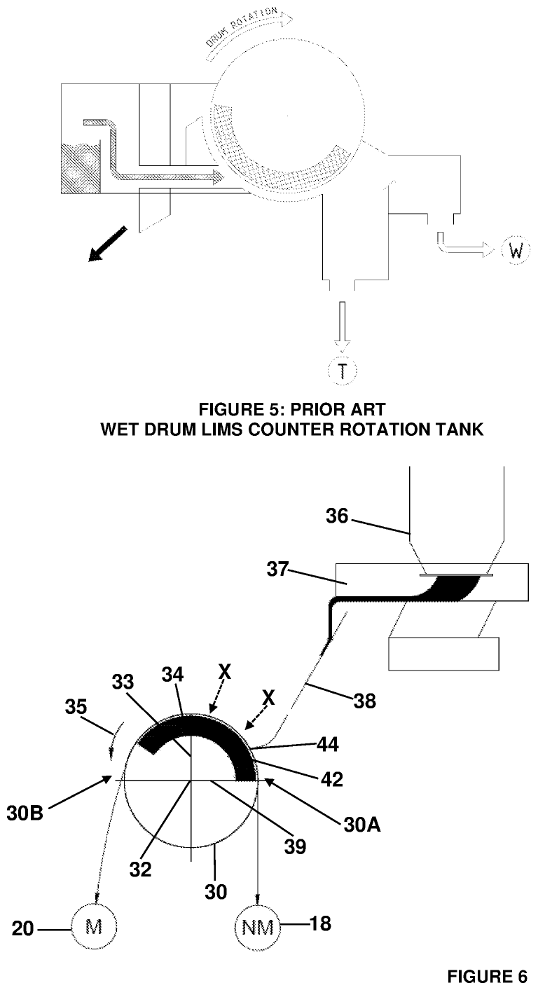

(vii) If the drum rotates against the direction of the slurry feed flow, the magnetic material is carried on the drum to a position above the feed point and the non-magnetic material leaves through drain holes at the bottom of the bath. This arrangement is known a counter rotation type wet drum separator and is illustrated in FIG. 5 (prior art).

Dense medium separation (DMS) refers to a process in which ore particles are separated from one another based on their specific gravities. Ore mixed with medium and water (slurry) is fed to a vessel in which separation of particles, lighter and heavier than the medium is made. The medium is strongly magnetic and is typically magnetite for low specific gravity separation (for example coal), and ferrosilicon for higher specific gravity material (such as diamonds or iron ore). The light (floats) and heavy (sink) particles leave the vessel with the medium and are fed to vibrating screens. In a first section of the screen medium of the correct separation density is drained and returned to the separation vessel; in the second section the particles are sprayed with water to rinse off the medium. The rinsed medium passes through fine aperture holes in a screen deck and is fed to wet drum LIMS for recovery and dewatering the medium, which then joins drained medium.

In a modern DMS plant the counter rotation wet drum LIMS is the preferred separator choice, as it can handle a greater amount of slurry and medium solids, than the con-current type (Rudman 2000). Particles of less than 0.5 mm are rejected ahead of the separation vessel as they will pass through the fine aperture screen, but they can be separated in so called “fines” DMS plants. In a fines plant the separated light and heavy particles with medium are fed directly to magnetic separators. In this variation the separators have an additional role, namely separation of the products and the medium. Operators of fines DMS plants have reported that the medium recovered on the prior art wet drum LIMS is not free of fine ore particles. Over time these build up in the medium returned to the separation vessel, lowering the separation density leading to ineffective product separation, and eventually the contaminated medium has to be discarded and replaced with new medium (Scholtz 2020).

### SUMMARY OF THE INVENTION

According to the invention there is provided a material feed process for magnetically separating magnetic and non-magnetic particles by means of a magnetic roller separator wherein the process is characterised therein that primary particle separation is independent of centrifugal force, the process comprising the steps of—

providing a magnetisable roller which rotates about an axis of rotation, and at least one magnet which is configured to create a magnetic field on the roller surface for at least a portion of the roller surface, the magnetic field being characterised therein that it is created at least partially to one side of the roller circumference relative to a vertical axis centre line and opposite to the rotation direction;

providing a feed hopper and accompanying feed chute for feeding material at an incident angle onto the roller;

feeding the material directly into the magnetic field on the roller surface from one side of the roller, at an incident zone which is above a horizontal axis centre line, such that primary particle separation occurs where feed particles first meet the roller surface in that the non-magnetic particles fall from the roller surface at the point of impact, under the influence of gravity, at one side of the roller; while the magnetic particles are trapped within the magnetic field and carried over in the magnetic field in the direction of rotation towards an opposite side of the roller and fall from the roller surface, under the influence of gravity, once they move outside of the magnetic field.

The incident zone may be 0°-45° above the horizontal axis centre line.

In one embodiment of the invention the roller may be rotating in an anti-clockwise direction and the magnet may be arranged such that the magnetic field is created on the roller circumference at least at a position of between approximately twelve-o'-clock and three-o'-clock relative to the axis of rotation. Feed material may be introduced onto the roller surface at the incident zone so that the material is fed directly into the magnetic field on the roller circumference, the arrangement being such that particle separation occurs at the point of impact where particles meet the roller surface and non-magnetic particles fall from the roller surface, under the influence of gravity, at a clockwise-side of the roller, while the magnetic particles are carried over in the magnetic field towards an anti-clockwise side of the roller and fall from the roller, under the influence of gravity, as soon as they move outside of the magnetic field.

It will of course be appreciated that in an alternative embodiment of the invention the roller may be rotating in a clockwise direction and the magnet may be arranged such that the magnetic field is created on the roller circumference at least at a position of between approximately nine-o'-clock and twelve-o'-clock relative to the axis of rotation. Feed material may be introduced onto the roller surface at the incident zone so that the material is fed directly into the magnetic field on the roller circumference, the arrangement being such that particle separation occurs at the point of impact where particles meet the roller surface and non-magnetic particles fall from the roller surface, under the influence of gravity, at an anti-clockwise side of the roller, while the magnetic particles are carried over in the magnetic field towards a clockwise side of the roller and fall from the roller, under the influence of gravity, as soon as they move outside of the magnetic field.

The process further may comprise the step of positioning the feed chute at an angle relative to the incident zone, and specifically at an angle of between approximately 50° to 70° to the horizontal, and preferably 60°. The feed chute may terminate in a feed chute outlet, which is angularly offset from a longitudinal axis of the feed chute, and the material feed assembly may provide configuring the feed chute outlet such that the feed material is introduced onto the roller surface at an incident angle of between approximately 10° to 20° relative to the horizontal. The feed chute outlet may terminate at a gap distance of between approximately 10 mm to 20 mm from the roller surface so as to allow non-magnetic particles to fall through the gap between the roller surface and the feed chute outlet at the point of impact.

The process further may comprise the step of feeding the feed material under free-fall conditions from a hopper onto the feed chute so as to reduce static friction between the feed material and the feed chute surface. The vertical free-fall distance between the hopper and the feed chute may typically be between 50 mm and 100 mm.

The process further may comprise the step of introducing the feed material particles onto the feed chute by means of a feeder of a vibrating or star roll type in order to increase the final velocity with which material particles meet the roller surface.

In a process of the invention where the magnetic roller separator is a REDS, a non-magnetic roller shell may rotate about an array of static magnets which are configured relative to the roller such that the magnetic field is created on the roller surface at least at a position of between approximately twelve-o'-clock and three-o'-clock relative to the axis of rotation of the roller, but can be positioned such that the magnetic field is created at between approximately nine-o'-clock and three-o'-clock relative to the axis of rotation, but either way such that it creates an incident zone at between 0° and 45° relative to the horizontal. When feed material is introduced onto the roller surface, non-magnetic particles fall from the roller surface at the point of impact, under the influence of gravity, at a clockwise-side of the roller, while the magnetic particles are retained by the magnetic field of the roller surface and are carried over to an anti-clockwise side of the roller, where they fall from the roller surface under the influence of gravity, as soon as they move outside of the magnetic field.

In a process of the invention where the magnetic roller separator is a RERS, a rotating magnet may be installed at a tail roller of a short belt conveyer such that the magnetic field is created at least at a position of between approximately twelve-o'-clock and three-o'-clock relative to the axis of rotation of the tail roller, but either way such that it creates an incident zone at between 0° and 45° relative to the horizontal. When feed material is introduced onto the belt conveyer, non-magnetic particles fall from the tail roller at the point of impact, under the influence of gravity, at a clockwise-side of the tail roller, while the magnetic particles are retained by the magnetic field of the tail roller and are carried over to the head roller, where they fall from an anti-clockwise side of the head roller, under the influence of gravity, as soon as they move outside of the magnetic field.

In the process of the invention where the magnetic roller separator is a RERS, a rotating magnet may additionally be installed at a head roller of the short belt conveyer to provide a secondary separation functionality, additionally to the primary separation functionality of the tail roller, such that when feed material is introduced onto the belt conveyer, non-magnetic particles are predominantly separated out at the tail roller under the influence of gravity, while the magnetic particles and any non-magnetic particles that might not have separated out at the tail roller are carried over in the magnetic field to the head roller where the non-magnetic particles are dispelled from the head roller under centrifugal force, while the magnetic particles fall from an anti-clockwise side of the head roller, under the influence of gravity, as soon as they move outside of the magnetic field. The process of the invention provides for the possibility of installing a magnetisable tail roller into an existing RERS without the need to replace the magnetisable head roller.

According to another aspect of the invention, there is provided a material feed assembly for feeding particle material from a hopper onto a magnetisable roller of a magnetic roller separator for magnetically separating magnetic and non-magnetic particles from the material feed, the material feed assembly comprising—

a magnetisable roller which rotates about an axis of rotation, and at least one magnet which is configured to create a magnetic field on the roller surface for a portion of the roller circumference, the magnetic field being characterised therein that it is created at least partially to one side of the roller circumference relative to a vertical axis centre line and opposite to the rotation direction;

a feed hopper and accompanying feed chute for feeding material onto the roller surface, the feed chute being disposed at an angle relative to the roller surface such that material is fed directly into the magnetic field on the roller surface from one side of the roller, offset from the horizontal;

the arrangement being such that primary particle separation occurs where feed particles first meet the roller surface in that the non-magnetic particles fall from the roller surface at the point of impact, under the influence of gravity, while the magnetic particles are trapped within the magnetic field and carried over in the magnetic field in the direction of rotation towards an opposite side of the roller and fall from the roller surface, under the influence of gravity, once they move outside of the magnetic field.

In the process of the invention where the process is adapted for DMS plant wet drum LIMS separation, the process may provide the steps of feeding the feed material in a slurry from a feed box down the inclined chute towards a magnetic drum such that when the slurry reaches the end of the chute, the magnetic particles will be attracted to the drum surface by the magnetic field, allowing non-magnetic ore and carrier water to fall from the drum surface at the point of impact, under the influence of gravity, at one side of the drum; while the magnetic particles are trapped within the magnetic field and carried over in the magnetic field in the direction of rotation towards an opposite side of the roller. At the opposite side of the drum, the magnetic particles may be scraped off the drum surface, at which position a strong magnet section may be fitted to squeeze water out of the magnetic particles, increasing density of recovered medium. The process may provide the step of providing a tank with three outlets installed under the magnetic drum—one outlet for ore with some water, one outlet for densified medium with some water, and one outlet for water with some medium that may be carried over with the water.

### SPECIFIC EMBODIMENT OF THE INVENTION

Without limiting the scope thereof, the invention will now further be described and exemplified with reference to the accompanying drawings wherein—

FIGS. 1-5 illustrate prior art configurations as discussed in the Background to the Invention;

FIG. 6 is a schematic illustration of a dry material feed process and assembly of the invention where the magnetic roller separator is a REDS;

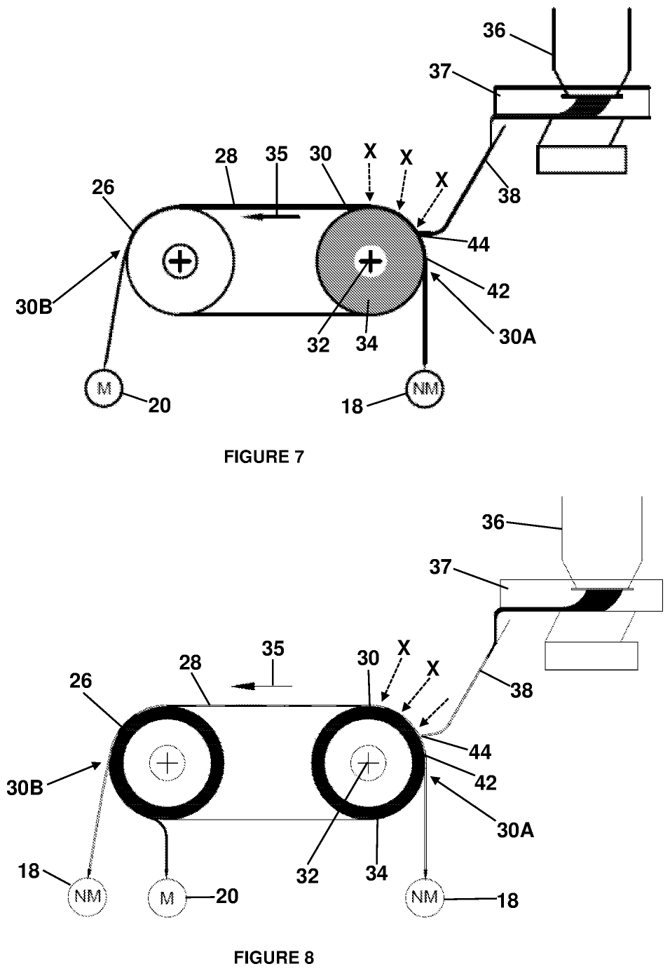

FIG. 7 is a schematic illustration of a dry material feed process and assembly of the invention where the magnetic roller separator is a RERS;

FIG. 8 is a schematic illustration of a RERS, such as in FIG. 7, but where a rotating magnet is additionally (and optionally) installed at a head roller of the short belt conveyer to provide a secondary separation functionality;

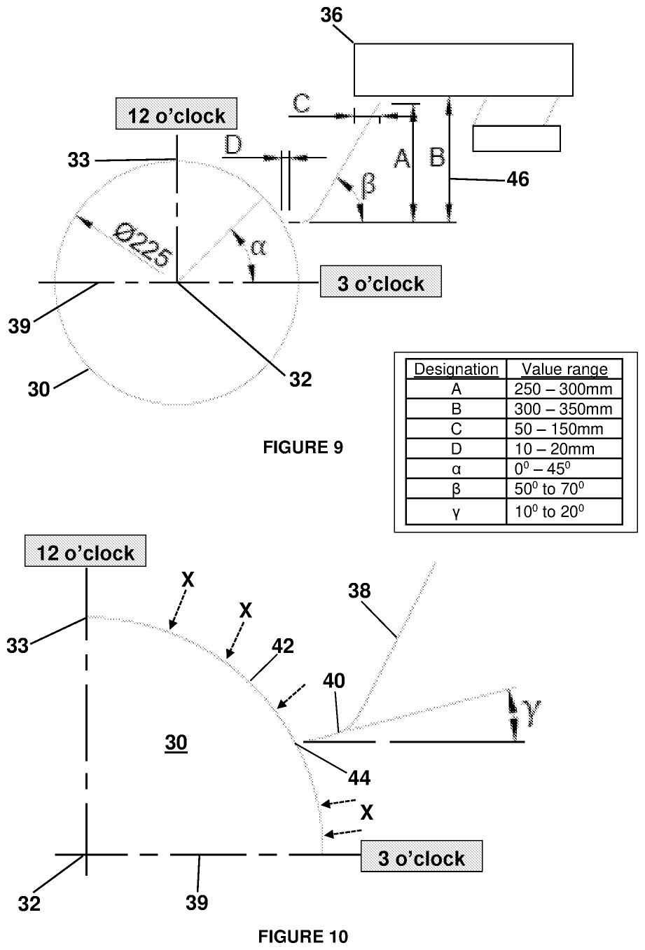

FIG. 9 is a schematic illustration of REDS, such as in FIG. 6, but illustrating the incident angle, chute angle and vertical distance between a hopper outlet and the incident zone;

FIG. 10 is an enlarged schematic illustration of the REDS of FIG. 9, more clearly illustrating the incident angle;

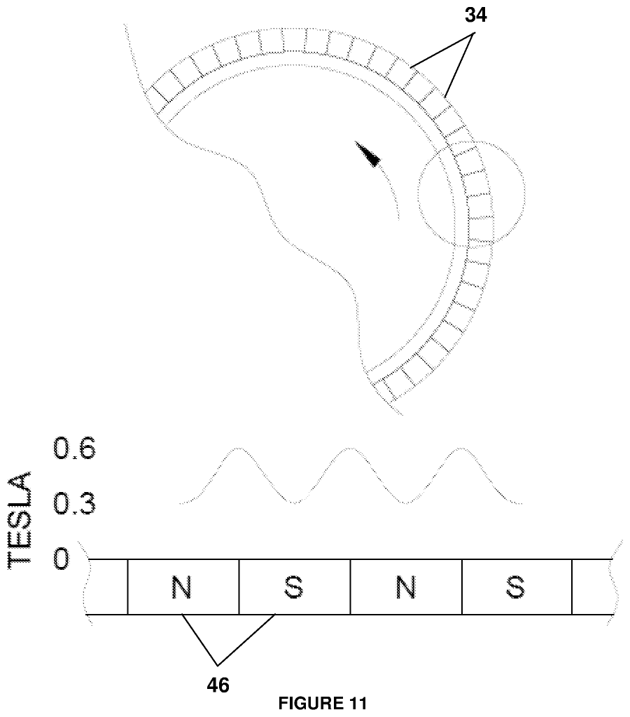

FIG. 11 illustrates a preferred configuration of the magnets on the roller; and

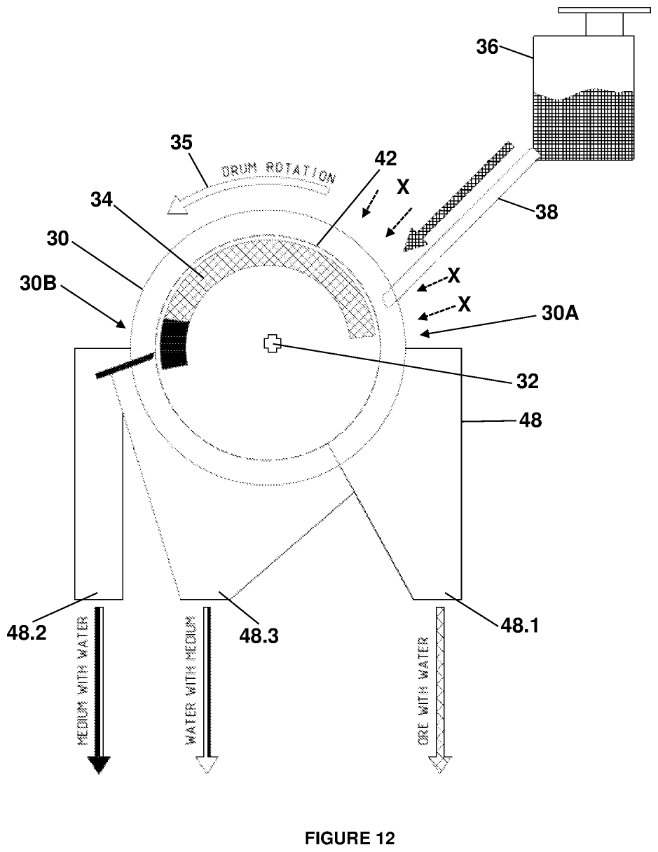

FIG. 12 is a schematic illustration of a wet material feed process and assembly of the invention where the magnetic separator is a Wet drum LIMS.

The material feed process according to the invention for magnetically separating magnetic and non-magnetic particles by means of a magnetic roller separator is characterised therein that primary particle separation is independent of centrifugal force. The process comprises the steps of providing a magnetisable roller [30] which rotates about an axis of rotation [32] and which is operatively associated with at least one magnet [34] which is configured to create a magnetic field [X] on the roller surface [42] for a portion of the roller circumference. The magnet [34] is arranged such that the magnetic field [X] is created at least partially to one side of the roller circumference relative to vertical axis centre line [33] and opposite to the rotation direction [35].

The process provides feeding the material directly into the magnetic field [X] on the roller surface [42] from one side of the roller [30], at an incident zone [α] which is above a horizontal axis centre line [39], such that primary particle separation occurs where feed particles first meet the roller surface [42] in that the non-magnetic particles [18] fall from the roller surface [42] at the point of impact [44], under the influence of gravity, while the magnetic particles [20] are trapped within the magnetic field [X] and are carried over in the magnetic field [X] in the direction of rotation [35] towards an opposite side of the roller [30] and fall from the roller surface [42], under the influence of gravity, once they move outside of the magnetic field [X].

In the illustrated embodiments of the invention the roller [30] is rotating in an anti-clockwise direction and the magnet [34] is arranged such that the magnetic field [X] is created on the roller circumference at least at a position of between approximately twelve-o'-clock and three-o'-clock relative to the axis of rotation [32]. Feed material is introduced onto the roller surface [42] at the incident zone [α] so that the material is fed directly into the magnetic field [X] on the roller surface [42], the arrangement being such that primary particle separation occurs at the point of impact [44] where particles meet the roller surface [42] and non-magnetic particles [18] fall from the roller surface [42], under the influence of gravity, at a clockwise-side [30A] of the roller [30], while the magnetic particles [20] are carried over in the magnetic field [X] towards an anti-clockwise side [30B] of the roller [30] and fall from the roller [30], under the influence of gravity, as soon as they move outside of the magnetic field [X].

In a preferred embodiment of the invention the incident zone [α] is between above the horizontal axis centre line [39].

The process further comprises the step of positioning the feed chute [38] at an angle relative to the incident zone [α], and specifically at an angle of between approximately 50° to 70° to the horizontal. The material feed assembly further provides for configuring a feed chute outlet [40] such that the feed material is introduced onto the roller surface [42] at an incident angle [γ] of between approximately 10° to 20° relative to the horizontal, and preferably 15°. The feed chute outlet [40] terminates at a gap distance [D] of between approximately 10 mm to 20 mm from the roller surface [42] so as to allow non-magnetic particles [18] to fall through the gap [D] between the roller surface [42] and the feed chute outlet [40] at the point of impact [44].

The process further comprises the step of feeding the feed material under free-fall conditions from a hopper [36] onto the feed chute [38] so as to reduce static friction between the feed material and the feed chute surface. The vertical free-fall distance between the hopper and the feed chute [38] is between 50 mm and 100 mm.

The process further comprises the step of introducing the feed material particles onto the feed chute [38] by means of a vibrating feeder [37] in order to increase the final velocity with which material particles meet the roller surface [42]. It will be appreciated that when feed material slides down the inclined chute [38], the velocity of the particles upon exiting the feed chute [38] is calculated as [Sqr 2×9.81×sin angle×chute length] (units are metres and seconds). However, if the initial velocity is increased through a vibrating feeder [37], the square root of this initial velocity is added to the final velocity calculation.

In a process of the invention where the magnetic roller separator is a REDS (refer FIG. 6), a non-magnetic roller [30] shell rotates about an array of static magnets [34] which are configured relative to the roller [30] such that the magnetic field [X] is created on the roller surface [42] at least at a position of between approximately twelve-o'-clock and three-o'-clock relative to the axis of rotation [32] of the roller [30], but can be positioned such that the magnetic field [X] is created at between approximately nine-o'-clock and three-o'-clock relative to the axis of rotation [32], but either way such that it creates an incident zone [α] at between 0° and 45° above the horizontal axis centre line [39]. When feed material is introduced onto the roller surface [42], non-magnetic particles [18] fall from the roller surface [42] at the point of impact [44], under the influence of gravity, at a clockwise-side [30A] of the roller [30], while the magnetic particles [20] are retained by the magnetic field [X] of the roller surface [42] and are carried over to an anti-clockwise side [30B] of the roller [30], where they fall from the roller surface [42] under the influence of gravity, as soon as they move outside of the magnetic field [X].

In a process of the invention where the magnetic roller separator is a RERS (refer FIG. 7), a rotating magnet [34] is installed at a tail roller [30] of a short belt conveyer [28] such that the magnetic field [X] is created at least at a position of between approximately twelve-o'-clock and three-o'-clock relative to the axis of rotation [32] of the tail roller [30], but either way such that it creates an incident zone [α] at between 0° and 45° above the horizontal axis centre line [39]. When feed material is introduced onto the belt conveyer [28], non-magnetic particles [18] fall from the tail roller [30] at the point of impact [44], under the influence of gravity, at a clockwise-side [30A] of the tail roller [30], while the magnetic particles [20] are retained by the magnetic field [X] of the tail roller [30] and are carried over by the belt [28] to the head roller [26], where they fall from an anti-clockwise side [30B] of the head roller [26], under the influence of gravity, as soon as they move outside of the magnetic field [X].

Referring to FIG. 8, in the process of the invention where the magnetic roller [30] separator is a RERS, a rotating magnet [34] additionally and optionally may be installed at a head roller [26] of the short belt conveyer [28] to provide a secondary separation functionality, additionally to the primary separation functionality of the tail roller [30], such that when feed material is introduced onto the belt conveyer [28], non-magnetic particles [18] are predominantly separated out at the tail roller [30] under the influence of gravity, while the magnetic particles [20] and any unwanted weakly magnetic particles [18] that might not have separated out at the tail roller [30], are carried over in the magnetic field [X] to the head roller [26], where the unwanted weakly magnetic particles [18] are dispelled from head roller [26] under centrifugal force, while the magnetic particles [20] fall from an anti-clockwise side [30B] of the head roller [26], under the influence of gravity, as soon as they move outside of the magnetic field [X]. The process of the invention provides for the possibility of installing a magnetisable tail roller [30] into an existing RERS without the need to replace the magnetisable head roller [26].

In one embodiment of the invention, the magnetic configuration on the magnetisable tail roller [30] comprises a plurality of small, permanent magnets [34] installed very close to each other, with their magnetic polarities [46] oriented at alternate north-south orientation.

### Experimental Results

In order to test the material feed process and assembly of the invention, the applicant configured a RERS assembly with a material hopper [36], vibrating feeder [37], inclined feed chute [38], magnetic tail roll [30], non-magnetic head roll [31] and a thin belt [28] of 0.13 mm. The inclined chute [38] was adjustable to make an acute angle alpha [α] with the magnetic roll [30]. The magnetic roll [30] comprised a carbon steel tube to which was attached small rectangular rare-earth neodymium permanent magnets [34]. The final diameter of the roll [30] with the magnets was 225 mm. The magnets [34] were arranged north-south (N-S) around the roll circumference, such that the magnetic force was the strongest where the N-S magnets abutted each other. Magnetic material attached to the strong magnetic lines formed across the roll face. The shorter the pitch was between the magnets, the more magnetic lines appeared to carry away the magnetic material.

### Test 1

The applicant tested a feed material comprising 99.5% sand and 0.5% hematite in a process according to the invention. Feed material was introduced onto the belt surface at an incident zone [α] of 35° from the horizontal, a feed chute angle [β] of 70°, and a feed chute outlet angle [γ] of 18°. The separator was run at a roller speed of 10 rpm and a belt speed of 0.12 m/s. Feed material was fed onto the separator at a feed rate of 6 t/h/m. For comparison, the same feed material comprising 99.5% sand and 0.5% hematite was run through a conventional RERS. The comparative results are depicted below with Table 1 depicting the test results of the prior art RERS process, and Table 2 depicting the test results of the RERS material feed process according to the invention.

The prior art material feed process (Table 1) provided a 99.74% separation of sand and 90% separation of hematite. However, this separation was only achieved after three passes (i.e. after the material was sent through the separator three times). In addition, this separation could only be achieved at a material feed rate of 2 t/h/m, and at a roller speed of 100 rpm and a belt speed of 0.52 m/s. The prior art magnetic roller comprised a series of neodymium permanent magnets sandwiched between steel discs (poles), diameter 100 mm. The capacity of 2 t/h/m for a 300 mm diameter roller can be scaled up using the diameter ratio as described in the Background to the invention, page 5, according to the equation Sqr 3/1=1.73×2 t/h/m=3.46 from (Jakobs 2016) not more than 4 t/h/m.

By comparison, the material feed process according to the invention (Table 2) provided a 99.89% separation of sand and 90% separation of hematite. However, this separation was with a single pass, at a higher material feed rate of 6 t/h/m, and at a roller speed of only 10 rpm and a belt speed of 0.12 m/s. Accordingly, the process of the invention was proven to provide the same separation efficiency at a significantly higher feed rate and capacity, while at the same time running the RERS at a lower roller speed and belt speed, thus reducing wear and tear typically associated with such separators.

### Test 2

The applicant tested a feed material comprising 95% ilmenite and 5% sand in a process according to the invention. Feed material was introduced onto the belt surface at an incident zone [α] of 0° from the horizontal, a feed chute angle [β] of 70°, and a feed chute outlet angle [γ] of 18°. The separator was run at a roller speed of 100 rpm and a belt speed of 1.12 m/s. In this test, the applicant included a magnetised head roller [26]. Feed material was fed onto the separator at a feed rate of 6 t/h/m. For comparison, the same feed material comprising 95% ilmenite and 5% sand was run through a conventional RERS. The comparative results are depicted below with Table 3 depicting the test results of the prior art RERS process, and Table 4 depicting the test results of the RERS material feed process according to the invention.

The prior art material feed process (Table 3) provided a 99.8% separation of ilmenite and 90% separation of sand. However, this separation was only achieved after two passes (i.e. after the material was sent through the separator twice). In addition, this separation could only be achieved at a material feed rate of 2 t/h/m.

By comparison, the material feed process according to the invention (Table 4) provided a 98.42% separation of ilmenite and 99% separation of sand. However, this separation was with a single pass, at a higher material feed rate of 6 t/h/m.

The roller [30] of the invention used neodymium magnets [34] for paramagnetic (weakly magnetic) minerals, but can work with ferrite magnets for ferromagnetic (strongly) magnetic material also.

The material feed process and assembly according to the invention may be adapted for both dry and wet magnetic separation. During wet separation, as illustrated in FIG. 12, the feed material is carried in a slurry and falls from a feed box [36] down the inclined chute [38] towards the magnetisable drum [30]. As the slurry reaches the end of the chute [38], magnetic particles will be attracted to the drum surface [42] by the magnetic field [X]. Non-magnetic ore and carrier water fall from the drum surface [42] at the point of impact, under the influence of gravity, at one side of the drum; while the magnetic particles are trapped within the magnetic field [X] and carried over in the magnetic field [X] in the direction of rotation towards an opposite side of the drum [30]. At the opposite side, the magnetic particles may be scraped off the drum surface [42]. As the magnetic particles are not pulled through moving slurry, the drum surface magnetic field strength can be lower than that used in prior art wet separators. At the position where the magnetic particles are scraped off the drum, a strong magnet section can be fitted. The strong magnet will squeeze water out of the magnetic particles, increasing the density of the recovered medium. A tank [48] with three outlets may be installed under the drum—one outlet [48.1] for ore with some water, one outlet [48.2] for densified medium with some water, and one outlet [48.3] for water with some medium that may be carried over with the water.

It will be appreciated that other embodiments of the invention are possible without departing from the spirit or scope of the invention as defined in the claims.

1. A material feed process for magnetically separating magnetic and non-magnetic particles by means of a magnetic roller separator wherein the process is characterised therein that primary particle separation is independent of centrifugal force, the process comprising the steps of—
providing a magnetisable roller [30] which rotates about an axis of rotation [32], and at least one magnet [34] which is configured to create a magnetic field [X] on the roller surface [42] for at least a portion of the roller surface [42], the magnetic field [X] being characterised therein that it is created at least partially to one side of the roller circumference relative to a vertical axis centre line [33] and opposite to the rotation direction [35];
providing a feed hopper [36] and accompanying feed chute [38] for feeding material at an angle onto the roller surface [42];
feeding the material directly into the magnetic field [X] on the roller surface [42] from one side of the roller [30], at an incident zone [α] which is above a horizontal axis centre line [39], such that primary particle separation occurs where feed particles first meet the roller surface [42] in that the non-magnetic particles [18] fall from the roller surface [42] at the point of impact, under the influence of gravity, at one side of the roller [30]; while the magnetic particles [20] are trapped within the magnetic field [X] and carried over in the magnetic field [X] in the direction of rotation [35] towards an opposite side of the roller [30] and fall from the roller surface [42], under the influence of gravity, once they move outside of the magnetic field.

2. The material feed process according to claim 1 wherein the incident zone [α] is 0°-45° above the horizontal axis centre line [39].

3. The material feed process according to claim 1 wherein the roller [30] rotates in an anti-clockwise direction and the magnet [34] is arranged such that the magnetic field [X] is created on the roller circumference at least at a position of between approximately twelve-o'-clock and three-o'-clock relative to the axis of rotation [32].

4. The material feed process according to claim 3 wherein the feed material is introduced onto the roller surface [42] at the incident zone [α] so that the material is fed directly into the magnetic field [X] on the roller circumference, the arrangement being such that particle separation occurs at the point of impact where particles meet the roller surface [42] and non-magnetic particles [18] fall from the roller surface [42], under the influence of gravity, at a clockwise-side of the roller [30], while the magnetic particles [20] are carried over in the magnetic field [X] towards an anti-clockwise side of the roller [30] and fall from the roller [30], under the influence of gravity, as soon as they move outside of the magnetic field [X].

5. The material feed process according to claim 1 wherein the roller [30] rotates in a clockwise direction and the magnet [34] is arranged such that the magnetic field [X] is created on the roller [30] circumference at least at a position of between approximately nine-o'-clock and twelve-o'-clock relative to the axis of rotation [32].

6. The material feed process according to claim 5 wherein the feed material is introduced onto the roller surface [42] at the incident zone [α] so that the material is fed directly into the magnetic field [X] on the roller circumference, the arrangement being such that particle separation occurs at the point of impact where particles meet the roller surface [42] and non-magnetic particles [18] fall from the roller surface [42], under the influence of gravity, at an anti-clockwise side of the roller [30], while the magnetic particles [20] are carried over in the magnetic field [X] towards a clockwise side of the roller [30] and fall from the roller [30], under the influence of gravity, as soon as they move outside of the magnetic field [X].

7. The material feed process according to claim 1 wherein the process further comprises the step of positioning the feed chute [38] at an angle relative to the incident zone [α].

8. The material feed process according to claim 7 wherein the feed chute [38] is positioned at an angle of between 50° to 70° to the horizontal, and preferably at an angle of 60°.

9. The material feed process according to claim 1 wherein the feed chute [38] terminates in a feed chute outlet [40], which is angularly offset from a longitudinal axis of the feed chute [38], and the process provides configuring the feed chute outlet [40] such that the feed material is introduced onto the roller surface [42] at an incident angle of between approximately 10° to 20° relative to the horizontal.

10. The material feed process according to claim 9 wherein the feed chute outlet [40] terminates at a gap distance [D] of between 10 mm to 20 mm from the roller surface [42] so as to allow non-magnetic particles [18] to fall through the gap between the roller surface [42] and the feed chute outlet [40] at the point of impact.

11. The material feed process according to claim 1 wherein the process further comprises the step of feeding the feed material under free-fall conditions from a hopper [36] onto the feed chute [38] so as to reduce static friction between the to feed material and the feed chute surface.

12. The material feed process according to claim 11 wherein the vertical free-fall distance between the hopper [36] and the feed chute [38] is between 50 mm and 100 mm.

13. The material feed process according to claim 1 wherein the process further comprises the step of introducing the feed material particles onto the feed chute [38] by means of a vibrating feeder [37] in order to increase the final velocity with which material particles meet the roller surface [42].

14. The material feed process according to claim 1 wherein the magnetic roller [30] separator is a REDS with a non-magnetic roller shell rotating about an array of static magnets [34] which are configured relative to the roller [30] such that the magnetic field [X] is created on the roller surface [42] at least at a position of between approximately twelve-o'-clock and three-o'-clock relative to the axis of rotation [32] of the roller [30], but can be positioned such that the magnetic field [X] is created at between approximately nine-o'-clock and three-o'-clock relative to the axis of rotation [32], but either way such that it creates an incident zone of between 0° and 45° relative to the horizontal axis centre line [39], such that when feed material is introduced onto the roller surface [42], non-magnetic particles [18] fall from the roller surface [42] at the point of impact, under the influence of gravity, at one side of the roller [30], while the magnetic particles [20] are retained by the magnetic field [X] of the roller surface [42] and are carried over to an opposite side of the roller [30], where they fall from the roller surface [42] under the influence of gravity, as soon as they move outside of the magnetic field [X].

15. The material feed process according to claim 1 wherein the magnetic roller [30] separator is a RERS with a rotating magnet [34] being installed at a tail roller [30] of a short belt conveyer [28] such that the magnetic field [X] is created at least at a position of between approximately twelve-o'-clock and three-o'-clock relative to the axis of rotation [32] of the tail roller [30], but either way such that it creates an incident zone at between 0° and 45° relative to the horizontal axis centre line [39], such that when feed material is introduced onto the belt conveyer, non-magnetic particles [18] fall from the tail roller [30] at the point of impact, under the influence of gravity, at one side [30A] of the tail roller [30], while the magnetic particles [20] are retained by the magnetic field [X] of the tail roller [30] and are carried over to the head roller [30], where they fall from an opposite side [30B] of the head roller [30], under the influence of gravity, as soon as they move outside of the magnetic field [X].

16. The material feed process according to claim 15 wherein a rotating magnet [34] is additionally installed at a head roller [30] of the short belt conveyer to provide a secondary separation functionality, additionally to the primary separation functionality of the tail roller [30], such that when feed material is introduced onto the belt conveyer, non-magnetic particles [18] are predominantly separated out at the tail roller [30] under the influence of gravity, while the magnetic particles [20] and any non-magnetic particles [18] that might not have separated out at the tail roller [30] are carried over in the magnetic field [X] to the head roller [30] where the non-magnetic particles [18] are dispelled from the head roller [30] under centrifugal force, while the magnetic particles [20] fall from an anti-clockwise side [30B] of the head roller [30], under the influence of gravity, as soon as they move outside of the magnetic field [X].

17. The material feed process according to claim 1 wherein the process is adapted for wet separation and provides the steps of feeding the feed material in a slurry from the hopper [36] down the inclined chute [38] towards the magnetic drum [30] such that when the slurry reaches the end of the chute [38], the magnetic particles [20] are attracted to the drum surface [42] by the magnetic field [X], allowing non-magnetic ore particles [18] and carrier water to fall from the magnetic drum surface [42] at the point of impact, under the influence of gravity, at one side [30A] of the magnetic drum [30]; while the magnetic particles [20] are trapped within the magnetic field [X] and carried over in the magnetic field [X] in the direction of rotation [35] towards an opposite side [30B] of the magnetic drum [30].

18. The material feed process according to claim 17 wherein at the opposite side [30B] of the roller [30], the magnetic particles [20] are scraped off the magnetic drum surface [42], at which position a stronger magnet section is fitted to squeeze water out of the magnetic particles, increasing density of recovered medium.

19. The material feed process according to claim 17 wherein the process provides the step of providing a tank [48] with three outlets installed under the magnetisable roller [30]—one outlet [48.1] for ore with some water, one outlet [48.2] for densified medium with some water, and one outlet [48.3] for water with some medium that carried over with the water.

20. A material feed assembly for feeding particle material from a hopper [36] onto a magnetisable roller [30] of a magnetic roller separator for magnetically separating magnetic and non-magnetic particles from the material feed, the material feed assembly comprising—
a magnetisable roller [30] which rotates about an axis of rotation [32], and at least one magnet [34] which is configured to create a magnetic field [X] on the roller surface [42] for at least a portion of the roller circumference, the magnetic field [X] being characterised therein that it is created at least partially to one side of the roller circumference relative to a vertical axis centre line [33] and opposite to the rotation direction [35];
a feed hopper [36] and accompanying feed chute [38] for feeding material onto the roller surface [42], the feed chute [38] being disposed at an angle relative to the roller surface [42] such that material is fed directly into the magnetic field [X] on the roller surface [42] from one side of the roller [30], offset from the horizontal;
the arrangement being such that primary particle separation occurs where feed particles first meet the roller surface [42] in that the non-magnetic particles [18] fall from the roller surface [42] at the point of impact, under the influence of gravity, while the magnetic particles [20] are trapped within the magnetic field [X] and carried over in the magnetic field [X] in the direction of rotation [35] towards an opposite side of the roller [30] and fall from the roller surface [42], under the influence of gravity, once they move outside of the magnetic field [X].
